(19) United States
(12) Patent Application Publication
(10) Pub. No.: US 2008/0255968 A1
(43) Pub. Date: Oct. 16, 2008

(54) TIME-BASED PHYSICAL INVENTORY MANAGEMENT

(75) Inventor: Matthias Heinrichs, Speyer (DE)

Correspondence Address: FISH & RICHARDSON, P.C., PO BOX 1022, MINNEAPOLIS, MN, 55440-1022, US

(73) Assignee: SAP AG, Walldorf (DE)

(21) Appl. No.: 11/734,414

(22) Filed: Apr. 12, 2007

(51) Int. Cl. G06Q 10/00

(52) U.S. Cl. 705/28

(57) ABSTRACT

The present disclosure relates to software for performing and managing physical inventory processing. The physical inventory processing may be performed by a software application. The software can be operable to analyze timestamp data associated with a physical count of the inventory and timestamps associated with a movement of goods in the physical inventory. The timestamp may include a date and a time to an appropriate level of granularity as to quickly or easily distinguish between goods movement or to appropriately process or ignore such movement in calculating book stock. The analysis can dynamically calculate book stock that reflects the physical inventory by comparing timestamp data over a particular time period. This physical count can be performed utilizing a scanning device that automatically associates an initial timestamp for an inventory item.

### TECHNICAL FIELD

This disclosure relates to inventory management and, more particularly, to systems, methods, and software implementing techniques for calculating book stock based on time-based movement of goods.

### BACKGROUND

A typical warehouse includes storage areas for storing stock. Such storage areas may include rows of shelves that accommodate a large number of storage bins. The storage bins on each shelf are usually labeled, as are the rows, for ease of identification. By knowing the relevant row and bin information, it is possible for warehouse workers to locate stock in the warehouse. In such cases, the row and bin of the desired stock is used like an address to locate the stock.

During normal warehouse operations, there are many transactions involving one or more different stock items each day. For example, there can be purchase order fulfillment, customer order fulfillment or shipment, returns, physical counts, breakages or other losses, scrap, and so forth. In addition, stock can be moved from one location in the warehouse to another for a variety of reasons. For example, it may be necessary to move stock from one bin location to another to better organize the stock, to locate certain stock in an area for inspection, and/or to prepare the stock for shipment outside of the warehouse. Typically, requests to move stock are issued as transfer orders. When a warehouse worker is given a transfer order, the worker must first locate the desired stock. A transfer order to transfer stock to a new location usually includes the stock's storage location, which is based on row and bin information retrieved from, for example, a computerized inventory system. Such a system maintains location information describing where stock is located in the warehouse. After receiving the transfer order, a warehouse worker will determine the location of the stock and travel to that location using the stock's row and bin information. The particular stock requested in the transfer order is then identified.

### SUMMARY

The present disclosure relates to software for performing and managing physical inventory processing. The physical inventory processing may be performed by a software application. The software can be operable to analyze timestamp data associated with a physical count of the inventory and timestamps associated with a movement of goods in the physical inventory. The timestamp may include a date, a time, and so forth (e.g., Mar. 3, 2010—00:00:00). The analysis can dynamically calculate book stock that reflects the physical inventory by comparing timestamp data over a particular time period. The physical count can be performed utilizing a scanning device that automatically associates an initial timestamp for an inventory item.

The software may be further operable to receive a delta based on goods movement. The delta may be a positive or negative number, resulting in an increase or decrease in stock quantities, respectively. In general, the software may automatically subtract the delta from the current book stock. For example, the software may determine a difference between book stock at a first timestamp and physical counts that have occurred at a second timestamp and subtract the difference from the current book stock. In one general aspect, the software may determine and perform the subtraction if the delta has been processed prior to the physical count. Similarly, the software may determine when to ignore the delta if the first timestamp is before the second timestamp.

Moreover, some or all of these aspects may be further included in respective systems or other devices for executing, implementing, or otherwise managing physical inventory. The details of these and other aspects and embodiments of the disclosure are set forth in the accompanying drawings and the description below. Other features, objects, and advantages of the various embodiments will be apparent from the description and drawings, as well as from the claims.

### DESCRIPTION OF DRAWINGS

FIG. 1 illustrates an example system for managing physical inventory in accordance with one implementation of the present disclosure;

FIG. 2 illustrates an example inventory management module and associated components in accordance with one embodiment of the system in FIG. 1;

FIGS. 3A and 3B illustrate examples of time-stamped book count data records in accordance with one implementation of the present disclosure;

FIG. 4 is a graphical implementation of the example data records in FIG. 3B; and

FIG. 5 illustrates an example process implementing physical inventory techniques and components in accordance with one implementation of the present disclosure.

### DETAILED DESCRIPTION

The present disclosure relates to methods, systems, and software for processing or otherwise managing physical inventory using time-stamped information. The time-stamped information can go to any level of granularity such that different inventory transactions can be differentiated and processed as appropriate. Moreover, such information may be in any format or of any length, as well as compressed to help reduce processing time, and/or encrypted to help protect the integrity of the information. This physical inventory processing may be performed by a company to track and manage stock quantities of goods, for example. In particular, the physical inventory software discussed in this disclosure may implement an end-to-end process used to check the actual physical stock levels and correct the stock levels captured in the system. Physical inventory processing may generally facilitate planning, distribution, and reporting activities for a particular company. For example, the physical inventory processing may include updating and recording materials, applying a timestamp to received and dispersed goods, moving goods, creating stock overview reports, and performing the physical inventory count to correct and/or update stock quantities stored in an inventory management system (e.g., reconciliation), just to name a few examples. The physical inventory of these goods (e.g., product, material, assembly, part, etc.) may represent an actual counted material in a warehouse at a particular time period. The physical inventory can include quantities of raw materials, operating supplies, semi-finished products, finished products, and trading goods or merchandise on hand in a company's storage facilities. In some embodiments, the term “physical inventory” can represent the action of determining the quantity of stock physically on hand by counting, weighing, measuring, or estimating, and the recording of the count results in the inventory management system.

The inventory management system may be any tool, application programming interface (API), application, or environment that allows a user to modify, configure, and utilize the stored inventory quantities and their related data. In certain cases, the inventory management system may provide on-demand cross-organizational capabilities, such as virtual networks of business partners who can obtain visibility of stock quantities across a whole supply chain. In some embodiments, the inventory management system may provide uninterrupted inventory usage (e.g., additions and deletions of stock) during a physical inventory count. For example, timestamps can be used to determine an exact physical inventory at one point in time by dynamically calculating differences in stock quantities according to accounting (e.g., book stock) and physical inventory (e.g., physical stock count).

In some embodiments, the techniques and components in this disclosure may operate independent of their calling software applications. As such, messaging, updates, and document exchanges can be performed synchronously or asynchronously using eXtensible Markup Language (“XML”) documents, Virtual Storage Access Method (“VSAM”) files, flat files, Btrieve files, comma-separated-value (“CSV”) files, or user interfaces. Document exchanges, such as inventory reports, may be received or retrieved in an interface internally (e.g., inventory management system) or externally (e.g., customer site). In some embodiments, the inventory management system can receive an XML document containing a stock modification (e.g., a physical movement of inventory) directly from an external interface. The XML document can be used to update inventory quantities or related data.

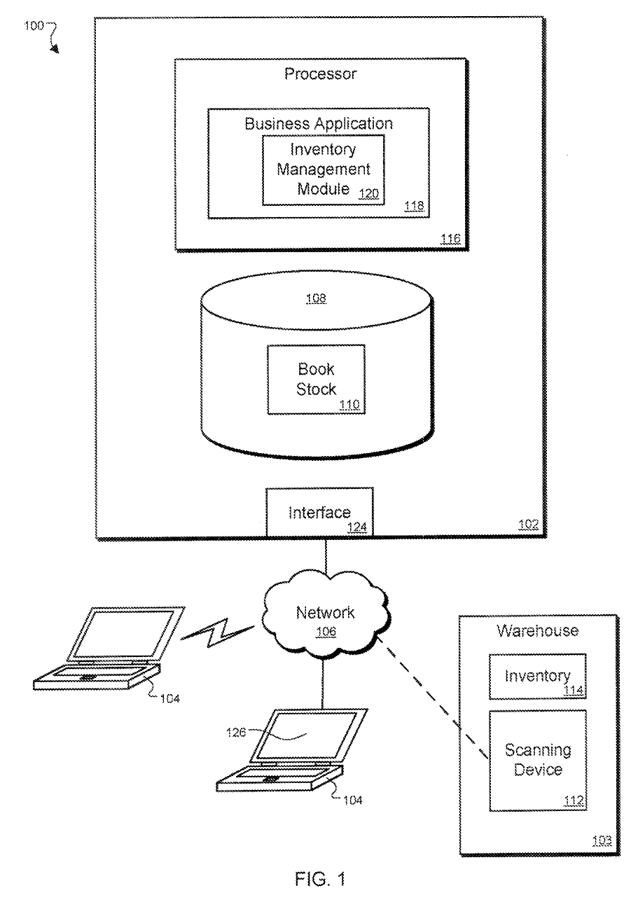

FIG. 1 illustrates an example physical inventory management system 100 that executes or otherwise implements physical inventory processing. The system 100 includes a server 102 for managing inventory, such as book stock 110. The server 102 can typically be accessed in a stand-alone fashion (such as a website), within any suitable productivity tool (whether enterprise software, email application, or others) selected by the user or automatically interfaced, or in a cooperative fashion with a third party search engine. In other words, system 100 may manage and share a knowledge base of software assets or other data services (often using metadata) that can easily be integrated into different developer and end user tools.

System 100 is typically a distributed client/server system that spans one or more networks, such as 108. As described above, rather than being delivered as packaged software, system 100 may represent a hosted solution, often for an enterprise or other small business that may scale cost-effectively and help drive faster adoption. In this case, portions of the hosted solution may be utilized by a first entity, while other components are utilized by a second entity. Moreover, the processes or activities of the hosted solution may be distributed amongst these entities and their respective components as well as other business partners in the supply chain. In some embodiments, system 100 may be in a dedicated enterprise environment—across a local area network or subnet—or any other suitable environment without departing from the scope of this disclosure.

Turning to the illustrated embodiment, system 100 includes or is communicably coupled (such as via a one-, bi-, or multi-directional link or network) with server 102, warehouse 103, and one or more clients 104, at least some of which communicate across network 106. Server 102 comprises an electronic computing device operable to receive, transmit, process, and store data associated with system 100. Generally, FIG. 1 provides merely one example of computers that may be used with the disclosure. Each computer is generally intended to encompass any suitable processing device. For example, although FIG. 1 illustrates one server 102 that may be used with the disclosure, system 100 can be implemented using computers other than servers, as well as a server pool. Indeed, server 102 may be any computer or processing device such as, for example, a blade server, general-purpose personal computer (“PC”), Macintosh, workstation, Unix-based computer, or any other suitable device. In other words, the present disclosure contemplates computers other than general purpose computers, as well as computers without conventional operating systems. Server 102 may be adapted to execute any operating system, including Linux, UNIX, Windows Server, or any other suitable operating system. According to one embodiment, server 102 may also include or be communicably coupled with a web server and/or a mail server.

Illustrated server 102 often includes local memory 108. Memory 108 may include any memory or database module and may take the form of volatile or non-volatile memory including, without limitation, magnetic media, optical media, random access memory (RAM), read-only memory (ROM), removable media, or any other suitable local or remote memory component. Illustrated memory 108 includes book stock 110. But memory 108 may also include any other appropriate data such as HTML files or templates, messages, data classes or object interfaces, unillustrated software applications or sub-systems, and others. Consequently, memory 108 may be considered a repository of data, such as a local book stock data repository for one or more applications.

Book stock 110 may include any or all current stock of a material according to accounting (or inventory) records. For example, the book stock 110 includes the quantities of inventory in one or more warehouses according to the accounting system. The book stock may be organized in any appropriate manner, including by item, by bin, by lot, by warehouse, by vendor, and so forth. Generally, a book stock count is continually updated following receipts and withdrawals over a particular time period. The book stock can be compared to actual physical stock on hand (by manually or electronically performing a physical inventory) to correct discrepancies in the stock quantities due to, for example, breakages, mistaken shipments, losses, and so forth.

Physical inventory 114 can generally be stored in one or more warehouses 103. Each warehouse 103 may be used by manufacturers, importers, exporters, wholesalers, transport businesses, customs, distributors, and other business partners in the supply chain. As is conventional, the warehouse 103 can be equipped with loading docks to load and unload trucks. Further, warehouse 103 may sometimes be loaded directly from railways, airports, or seaports. In some embodiments, the warehouse 103 may be automated (i.e., with few or no workers working inside). In this example, pallets and product can be moved with a system of automated conveyors and automated storage and retrieval machines coordinated by programmable logic controllers and computers running logistics automation software. Using such loading procedures, inventoried goods may be transported, shipped, or otherwise moved, with such movements providing information to the inventory management system.

In general, inventory movement information (e.g., stock) can be provided with an electronic tag, barcode, or other scannable/readable device such that an item's location and quantity can be tracked in the system 100 by simply scanning the item. For example, scanning (e.g., receiving) an item into inventory (say, due to a purchase order or a return) can increase the stock quantity by one (e.g., one item, one pallet, one device, etc.) and thus increase the physical stock. In another example, a shipment may be ordered and picked, which reduces the physical stock. Further, the timestamp can be appended to, embedded in, or otherwise associated with any or all transactions in the system, including initial receipt or stock build, stock use, stock movement to other locations, and physical inventory counts. Provision of the timestamp helps enable an inventory management entity (e.g., inventory management module 120) to calculate the book stock that reflects the physical inventory at any point in time. This may further facilitate the calculation of the difference between the quantity from stock taking and the book stock quantity.

The timestamp can be applied, retrieved and structured in various formats. For example, the timestamp may comprise a date and an eight-digit time value (e.g., Mar. 28, 2010, 01:12:30). Other formats are possible. The data may be coded, encrypted, sorted, or otherwise manipulated to facilitate the system 100. In operation, the timestamp can be appended to a particular stock item identification device (e.g., tag) using a scanning device 112. The scanning device 112 generally includes decoder circuitry for analyzing scanned data provided by wanding or coding information into the device 112. The data can be encrypted or otherwise manipulated to facilitate use of the scanned information. Generally, the scanning device may be handheld or affixed and can be operated manually or automatically. Examples of scanning device 112 can include, without limitation, a barcode scanner, a radio frequency scanner, an infrared scanner, an LED scanner, a line scanner, a laser scanner, or other suitable devices, including any combination of the above. For example, the scanning device 112 may include an RFID (radio frequency identification) scanner and a bar code scanner combined in one device. In some embodiments, multiple scanning devices can be used depending on the size and/or quantity of items being scanned. For example, a pallet may be counted and time stamped with an RFID scanner, while the individual pieces in the pallet may be counted and time stamped with a barcode scanner during a physical inventory. As such, multiple identification measures can be used on stock items to input and output stock data.

In some embodiments, the scanning device 112 can be used as part of the processing, whether the movement or counting, in warehouse 103. Warehouse 103 can communicate scanned data (via scanning device 112), including stock quantities and stock content data, to server 102 via network 106. The data can be communicated during a physical inventory to ensure the book stock is accounted for correctly. In some embodiments, the communication can occur as soon as the scan is made. For example, new inventory in the warehouse 103 can be updated in the accounting system upon scanning the received items. Thus, the book stock can more precisely remain in synchronicity with actual physical inventory 114.

Returning to server 102, it also includes processor 116. Processor 116 executes instructions and manipulates data to perform the operations of server 102 such as, for example, a central processing unit (“CPU”), a blade, an application specific integrated circuit (“ASIC”), or a field-programmable gate array (“FPGA”). Although FIG. 1 illustrates a single processor 116 in server 102, multiple processors 116 may be used according to particular needs and reference to processor 116 is meant to include multiple processors 116 where applicable. In the illustrated embodiment, processor 116 executes or requests execution of at least business application 118 and inventory management module 120.

The techniques and components described herein may be implemented within an enterprise resource computing system, such as business application 118. At a high level, business application 118 is any application, program, module, process, or other software that may execute, change, delete, generate, or otherwise request inventory modifications, according to the present disclosure. The business application 118 may be stored in a nonvolatile storage location, such as a distributed storage device or other repository (perhaps exterior to the server 102), and (some or all) be transferred to memory 108 for active use by the system 100. Memory 108 may include, point to, reference, or otherwise store business data used by the business application 118 or the inventory management module 120. In certain cases, system 100 may implement a composite application 118. For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET. Application 118 may be a child or sub-module of another software module or enterprise application (not illustrated) without departing from the scope of this disclosure. Indeed, application 118 may be a hosted solution that allows multiple parties in different portions of the process to perform the respective processing. For example, client 104 may access application 118 on server 102, or even as a hosted application located over network 106, without departing from the scope of this disclosure.

More specifically, business application 118 may be a composite application, or an application built on other applications, that includes an object access layer (OAL) and a service layer. In this example, application 118 may execute or provide a number of application services, such as logistics inventory management (LIM), customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help composite application 118 to orchestrate a business process in synchronization with other existing processes (e.g., native processes of enterprise base systems) and leverage existing investments in the IT platform. Further, composite application 118 may run on a heterogeneous IT platform. In doing so, composite application 118 may be cross-functional in that it may drive business processes across different applications, technologies, and organizations. Accordingly, composite application 118 may drive end-to-end business processes across heterogeneous systems or sub-systems. Application 118 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes the composite application 118, it may instead be a standalone or (relatively) simple software program. Regardless, application 118 may also perform processing automatically, which may indicate that the appropriate processing is substantially performed by at least one component of system 100. It should be understood that this disclosure further contemplates any suitable administrator or other user interaction with application 118, or other components of system 100, without departing from its original scope. Finally, it will be understood that system 100 may utilize or be coupled with various instances of business applications 118. For example, client 104 may run a first business application 118 that is communicably coupled with a second business application 118. Each business application 118 may represent different solutions, versions, or modules available from one or a plurality of software providers or may be developed in-house. In some instances, multiple business applications 118 may request inventory reconciliations that can be run in parallel using the same inventory management module 120.

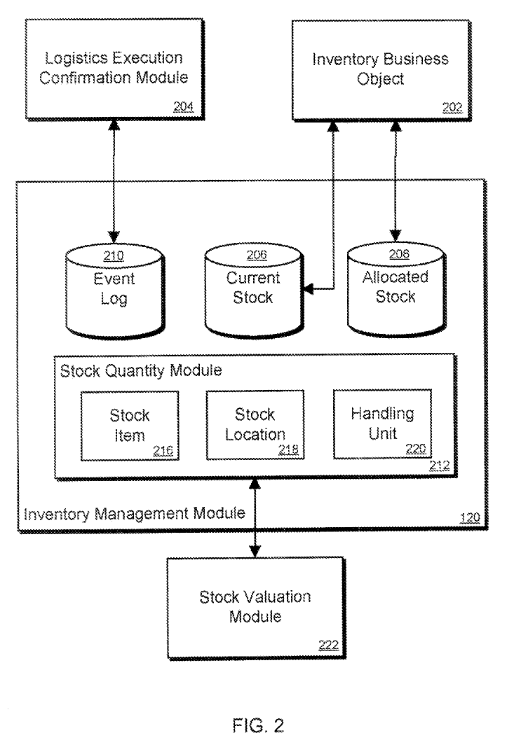

At a high level, inventory management module 120 is any application, program, module, process, or other software that may execute, change, delete, generate, timestamp, or otherwise manage inventory operations, according to the present disclosure. Overall, the inventory management module 120 can be used to manage physical stock at various different levels. For example, the inventory management module 120 can manage physical stock for one company at one site, for multiple sites of a company, for multiple systems, or for multiple companies. More particularly, the inventory management module 120 can be used to receive, process, select, or otherwise identify a timestamp for every movement of goods within the warehouse 103. For example, a first timestamp can be associated with receiving stock, while a second timestamp can be associated with the physical inventory count process. The inventory management module 120 can dynamically calculate the book stock at any point in time and also calculate the difference between the quantity from stock taking and the book quantity. Further example detail regarding the inventory management module 120 will be described with respect to FIG. 2.

Server 102 may also include interface 124 for communicating with other computer systems, such as clients 104, over network 106 in a client-server or other distributed environment. In certain embodiments, server 102 receives data from internal or external senders through interface 124 for storage in memory 108, for storage in a database, and/or processing by processor 116. Generally, interface 124 comprises logic encoded in software and/or hardware in a suitable combination and operable to communicate with network 106. More specifically, interface 124 may comprise software supporting one or more communications protocols associated with communications network 106 or hardware operable to communicate physical signals.

Network 106 facilitates wireless or wireline communication between computer server 102 and any other local or remote computer, such as clients 104. Network 106 may be all or a portion of an enterprise or secured network. In another example, network 106 may be a VPN merely between server 102 and client 104 across wireline or wireless link. Such an example wireless link may be via 802.11a, 802.11b, 802.11g, 802.20, WiMax, and many others. While illustrated as a single or continuous network, network 106 may be logically divided into various sub-nets or virtual networks without departing from the scope of this disclosure, so long as at least portion of network 106 may facilitate communications between server 102 and at least one client 104. For example, server 102 may be communicably coupled to one or more “local” repositories through one sub-net, while communicably coupled to a particular client 104 or “remote” repositories through another. In other words, network 106 encompasses any internal or external network, networks, sub-network, or combination thereof operable to facilitate communications between various computing components in system 100. Network 106 may communicate, for example, Internet Protocol (“IP”) packets, Frame Relay frames, Asynchronous Transfer Mode (“ATM”) cells, voice, video, data, and other suitable information between network addresses. Network 106 may include one or more local area networks (“LANs”), radio access networks (“RANs”), metropolitan area networks (“MANs”), wide area networks (“WANs”), all or a portion of the global computer network known as the Internet, and/or any other communication system or systems at one or more locations. In certain embodiments, network 106 may be a secure network associated with the enterprise and certain local or remote clients 104.

Client 104 is any computing device operable to connect or communicate with server 102 or network 106 using any communication link. For example, client 104 is intended to encompass a personal computer, touch screen terminal, workstation, scanning device 112, network computer, kiosk, wireless data port, smart phone, personal data assistant (“PDA”), one or more processors within these or other devices, or any other suitable processing device. At a high level, each client 104 includes or executes at least GUI 126 and comprises an electronic computing device operable to receive, transmit, process, and store any appropriate data associated with system 100. It will be understood that there may be any number of clients 104 communicably coupled to server 102. Further, “client 104,” “business partner,” and “user” may be used interchangeably as appropriate without departing from the scope of this disclosure. Moreover, for ease of illustration, each client 104 is described in terms of being used by one user. But this disclosure contemplates that many users may use one computer or that one user may use multiple computers. For example, client 104 may be a PDA operable to wirelessly connect with external or unsecured network. In another example, client 104 may comprise a laptop that includes an input device such as a barcode scanner, RFID scanner, keypad, touch screen, mouse, or other device that can accept information, and an output device that conveys information associated with the operation of server 102 or clients 104, including digital data, visual information, or GUI 126. Both the input device and output device may include fixed or removable storage media such as a magnetic computer disk, CD-ROM, USB drive, or other suitable media to both receive input from and provide output to users of clients 104 through the display, namely, the client portion of GUI or application interface 126.

GUI 126 comprises a graphical user interface operable to allow the user of client 104 to interface with at least a portion of system 100 for any suitable purpose, such as viewing application, inventory, or other transaction data. Generally, GUI 126 provides the particular user with an efficient and user-friendly presentation of data provided by or communicated within system 100. For example, GUI 126 may present the user with the components and information that is relevant to their task, increase reuse of such components, and facilitate a sizable developer community around those components. GUI 126 may comprise a plurality of customizable frames or views having interactive fields, pull-down lists, and buttons operated by the user. For example, GUI 126 is operable to display certain data services in a user-friendly form based on the user context and the displayed data. In another example, GUI 126 is operable to display different levels and types of information involving data services based on the identified or supplied user role. GUI 126 may also present a plurality of portals or dashboards. For example, GUI 126 may display a portal that allows users to view, create, and manage historical and real-time reports including role-based reporting and such. Of course, such reports may be in any appropriate output format including PDF, HTML, and printable text. Real-time dashboards often provide table and graph information on the current state of the data, which may be supplemented by data services. It should be understood that the term graphical user interface may be used in the singular or in the plural to describe one or more graphical user interfaces and each of the displays of a particular graphical user interface. Indeed, reference to GUI 126 may indicate a reference to the front-end of inventory management module 120, as well as the particular interface accessible via client 104, as appropriate, without departing from the scope of this disclosure. Therefore, GUI 126 contemplates any graphical user interface, such as a generic web browser or touchscreen, that processes information in system 100 and efficiently presents the results to the user. In some embodiments, server 102 can accept data from client 104 via the web browser (e.g., Microsoft Internet Explorer or Mozilla Firefox) and return the appropriate HTML or XML responses to the browser using network 106.

FIG. 2 illustrates an example inventory management module 120 and associated components. But, of course, inventory management module 120 may take various forms so long as it can implement or request one or more of the techniques described herein. In short, the inventory management module 120 is an engine used for the management of stock quantities for logistics processes. The management of stock quantities generally includes keeping a record of stock quantities, recording stock changes resulting from goods movements and/or inventory reports, and answering queries about stock quantities and stock movements. In particular, the module 120 can determine which quantity of a physical stock is stored in which handling unit at which location. In this instance, a handling unit (HU) 220 represents a physical unit consisting of packaging materials and the material contained in them. An HU can include a single, scannable identification number that can be used to call up the data for the handling unit.

The inventory management module 120 may be operated with or without a user interface. For example, a calling application 118 may invoke the inventory management module 120 to receive inventory data. The calling application 118 generally includes a user interface that allows users to enter stock movement or physical inventory data. The application 118 may process user-entered data and send the data to the inventory management module 120. Alternatively, the inventory management module 120 can receive an XML document directly from an external interface. For example, the module 120 can receive stock movement data from an external business partner (e.g., stock vendor).

In some instances, the inventory management module 120 extracts its own data from the incoming documents (e.g., location, handling unit, stock quantities, etc.) and maps the data to its internal components (e.g., databases). The extracted data can be used to update the stock quantities in the module 120. Another aspect of the inventory management module 120 is that it generally reflects the current physical stock at any selected time. In other words, the inventory management module 120 described here reflects physical quantities of stock rather than the stock values. Stock values include the total quantity of a material held in stock under a certain material number and belonging to the company holding the material. For example, a stock value may be used for a plant, a company code, a valuation type, or a storage location, to name a few examples.

In one instance, the inventory management module 120 can support various stock types such as unrestricted stock, quality inspection stock, blocked stock, and others. In particular, the module 120 can be used to manage specialized stock such as vendor or customer consignment stock, subcontractor's stock, returnable packaging, customer stock, project stock, promotion stock, and others.

Turning to the illustrated embodiment, the inventory management module 120 is generally utilized by an inventory business object 202 and a logistics execution confirmation module 204. The inventory business object 202 represents a quantity of all the materials (e.g., stock) in a location including the material reservations at this location. As such, the inventory business object 202 may have access to retrieve or modify information from a current stock database 206 and an allocated stock database 208. Information in the current stock database 206 and the allocated stock database 208 can be used to compare book stock with physically counted stock. In some embodiments, the databases 206, 208 can be analyzed to determine a particular time an item was scanned for distribution, sale, or internal use. The information can be analyzed and sent to the logistics execution confirmation module 204 for inventory updating purposes, or in some embodiments, for further analysis.

The logistics execution confirmation module 204 combines various functions for supply chain execution and manufacturing execution. For example, the logistics execution confirmation module 204 can support integration with supply chain control and accounting to enable a consistent view of inventory and resources. In addition, the module 204 can actively manage and coordinate orders, operations and tasks in physical production and site logistics over all fulfillment stages. For example, the logistics execution confirmation module 204 can provide warehouse logistics capabilities, central task management for warehouse and production, and advanced inventory management capabilities. In some embodiments, the logistics execution confirmation module 204 supports real-time analytics, monitoring and quality management functions, as well.

In general, the logistics execution confirmation module 204 can include various business objects (not shown) to carry out business operations. In some embodiments, the module 204 includes a goods and activity confirmation business object, a production confirmation business object, and a site logistics confirmation business object. The goods and activity confirmation business object represents an object that contains actual data reflecting ‘ad-hoc’ executed work (e.g., scrapping, goods issue for account assignment, change of stock category, etc.). In other words, execution was not pre-planned based on a production or site logistics order.

The production confirmation business object represents a record of confirmed logistic process changes which result from the execution of a production process at a specific time. This may include inventory changes, plan adjustments, resource utilizations, service product consumptions, work-in-process quantity changes, and progress status changes.

The site logistics confirmation business object represents a record of confirmed logistic process changes which may result from the execution of a site logistics process at a specific time. This may include inventory changes, plan adjustments, resource utilizations, and progress status changes.

The logistics execution confirmation module 204 may have access to retrieve or modify the above business object information from an event log database 210. The event log database 210 may include several inventory events, including additions, deletions, transfers, and reconciliations of stock performed by the inventory management module 120. Events in the event log database 210 can be time stamped as they occur. Similarly, an item of stock involved in the event can be time stamped with the same information to tie the transaction together. For example, the scanning device can scan an item and determine when and where the item was entered, exited, or transferred. Since the database is shared and/or reconciled at some point in time, a user can access the inventory management module information from client 104, for example, to determine the same item information.

The illustrated inventory management module 120 also includes a stock quantity module 212. The stock quantity module 212 includes data pertaining to current stock 206. Generally, stock data can be updated in the stock quantity module 212 as inventory changes are made. The details for any or all stock can include a stock item 216, a stock location 218, and a handling unit 220. The stock item 216, stock location 218, and handling unit 220 may represent several index tables or database tables holding various stock data. In particular, the stock item 216 (or stock unit) may be the smallest entity which is handled and can be identified in logistics processes. Examples include materials, trade items, stock-keeping units (SKUs), batches, global trade item numbers (GTINs), or combinations of material and order numbers.

The stock location 218 typically describes the physical place where an item can be stored. The stock location 218 may be a warehouse, a bin location, a partner, or, in some cases, a moving location (truck, tank ship, etc.). Thus, stock location 218 can span an entire supply chain. The handling unit 220 represents a combination of stock units or other handling units (e.g., cardboard boxes on a pallet). In one embodiment, a hierarchy of handling units can be created with several handling units 220. Handling units 220 can be identified according to serial shipment container codes (SSCCs), pallet numbers, package numbers, and other identifying mechanisms.

The system shown in FIG. 2 also includes a stock valuation module 222. The stock valuation module 222 can calculate the value of all fixed and current assets and of all payables at a certain time and in line with the appropriate legal requirements. As is conventional, valuation can be described as the process of identifying or calculating cost accounting values for profitability analysis. The stock valuation module 222 can perform valuations using conditions and pricing procedures, material cost estimates, and user-defined valuation routines.

The stock quantity module 212 and the stock valuation module 222 may be used to bridge the separation of stock quantities and stock values. In other words, the information gap between logistics execution and financial accounting regarding inventory can be bridged using the quantity module 212 and the stock valuation module 222. For example, if a stock movement invokes a value update, the material valuation is not performed in the inventory management module 120, but rather is performed in another application (e.g., application hosting the stock value module 222). Accordingly, the stock movement that is relevant to valuation may be communicated to the stock valuation module 222, where the stock can be valuated.

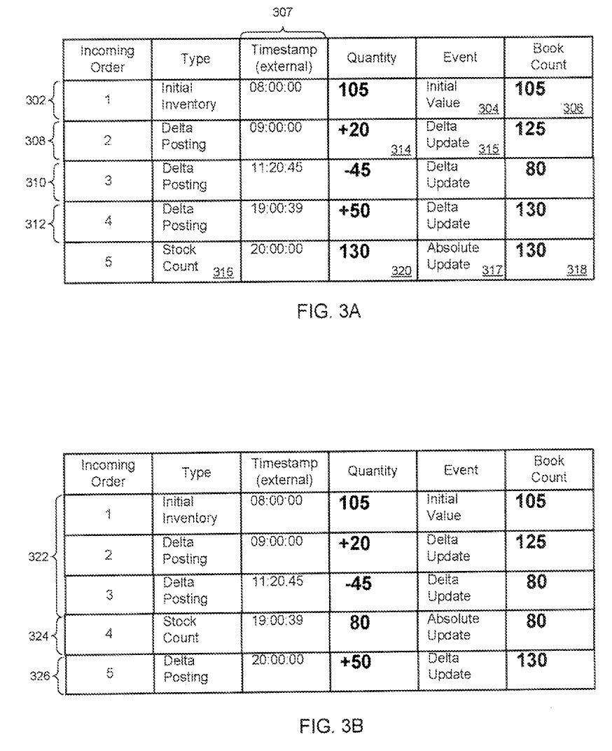

FIGS. 3A and 3B illustrate examples of time-stamped book count data records according to one implementation. The data records may be provided, created, and/or accessed from inventory management module 120, for example. Inventory module 120 may receive delta updates and absolute stock updates and process the data for the system 100. The data records shown in FIGS. 3A and 3B include initial inventory, delta postings, and stock counting activities provided with a timestamp of when the activity occurred and a corresponding quantity of items in the current inventory system 100. Initial inventory may include actual book stock in the system according to accounting. In some embodiments, each new day can begin with initial inventory as the predetermined book stock.

Delta postings may occur as inventory is added, removed, sold, purchased, transferred, or otherwise moved to, from, or around the system 100. Stock counting may occur at the end of a shift, day—or other suitable time period—and involves the physical count of any appropriate subset of the inventory. In some cases, the stock counting can be used to update or reset the book stock.

As shown, a first record 302 is an initial inventory record (e.g., incoming order) performed at 08:00:00 where the quantity of a stock item is 105 units. The activity is an initial value count 304 that provides a book count 306 of 105 units. Here, the book count matches the quantity in the inventory management module 120 and the system is balanced at the timestamp of 08:00:00. The timestamp 307 is generally applied when an inventory item is moved, added, or deleted from the system. Although the timestamp 307 in FIG. 3A does not indicate a date, a date is typically available to the system on any or all timestamps. If a larger information set were to be used, the date can be provided to differentiate between timestamp microseconds, seconds, minutes, hours, or any other level of granularity.

In a similar fashion to the first record 302, a second 308, third 310, and fourth 312 record are each shown occurring throughout the illustrated period. The second record adds 20 units (314) to the quantity. The addition may invoke a delta update event 315 to be performed by system 100 to update the book count to the correct value (e.g., initial count (105)+delta posting (20)=125). Similarly, subtracting inventory quantities as shown in record 310 can be reconciled in the system with a delta update transaction. At the end of a business day, for example, a physical stock counting 316 for the location shown in FIG. 3A can be performed. Thus, an absolute update event 317 can be performed and as shown, a book count 318 matches a physical quantity 320. In this example, the inventory accounting may be considered in balance.

In some embodiments, the physical stock count may be performed, while earlier activities (e.g., additions, deletions of inventory) may not be processed by system 100 until after this physical stock is processed. Such lack of processing may occur for suitable reason, including failure to input data, lack of communication, equipment failure, batch processing delay, and so forth. As an example and turning to FIG. 3B, a case is provided that includes previously occurring delta postings that arrived later than the stock count activity. Similar to FIG. 3A, the incoming orders 322 are posted and the book count is updated accordingly. Next, a stock count 324 is performed and an absolute update is performed based on differences. For example, the stock count may be lower than the book count because of theft or a mistake in operator handling of a particular material. In some embodiments, the stock count can be higher than the book count, such as if production returns materials to a lot storage, but fails to enter or scan the material into stock.

As shown in FIG. 3B, a delta posting 326 is performed after the stock count 324. In this example, the delta posting 326 is adding 50 units to inventory. In some embodiments, the inventory management module 120 generally accounts for the 50 units by processing the delta posting 326 and updates the book count. For example, the “late” delta posting 326 can be processed if a particular posting document (e.g., incoming order) does not include a timestamp. However, the inventory management module 120 generally uses the timestamp to properly reflect the physical inventory according to date and time received in the system.

In one example, the module 120 can generally recognize whether a timestamp occurred before another event in the system. As such, the system may not process the accounting update for the delta posting 326 at all or until the next day if the timestamp occurs after the performance of the stock count 324. For example, the module 120 may identify a first timestamp associated with an initial scan during a physical inventory count. Next, the module 120 may identify a second timestamp associated with a goods movement (e.g., delta posting) and dynamically determine a difference between book stock at the first timestamp and the physical count at that time. The module 120 may then analyze the timestamp and process the delta posting or reject the delta posting. Accepting the delta posting may include subtracting the difference from the current book stock, or, in the event of a negative count (e.g., an inventory increase), the current book stock can be increased by the amount received in the delta posting.

In general, delta postings that occur after or during an event such as physical inventory or stock counting, can be rejected, and the inventory in the inventory management module 120 can remain unchanged. In other words, the determination between book stock and physical count can be performed if the delta posting is processed prior to the physical stock count (e.g., record 324). In some embodiments, the system may send an information message to one or more users who performed the rejected delta posting. In some cases, the system may receive absolute postings after one or more delta postings were in progress, but before the stock count was finalized. In this case, the inventory management module 120 may update the stock quantity and set the quantity to the sum of the absolute and the delta postings that have a later timestamp than the current absolute posting. This example may occur if the system is using a logging functionality, such that the inventory management module 120 can determine which delta updates included timestamps later than that of the absolute posting. Moreover, this processing may occur on any suitable subset of the physical inventory, including by item, by bin, by lot, and so forth. In this way, the inventory management module 120 may merely ignore certain previously occurring deltas because the physical count transaction was for the related subset, while processing the unrelated transactions. For example, if a physical count was for a first bin, but a previously occurring movement of goods comes in for a second bin, then it can be processed and applied to the book stock.

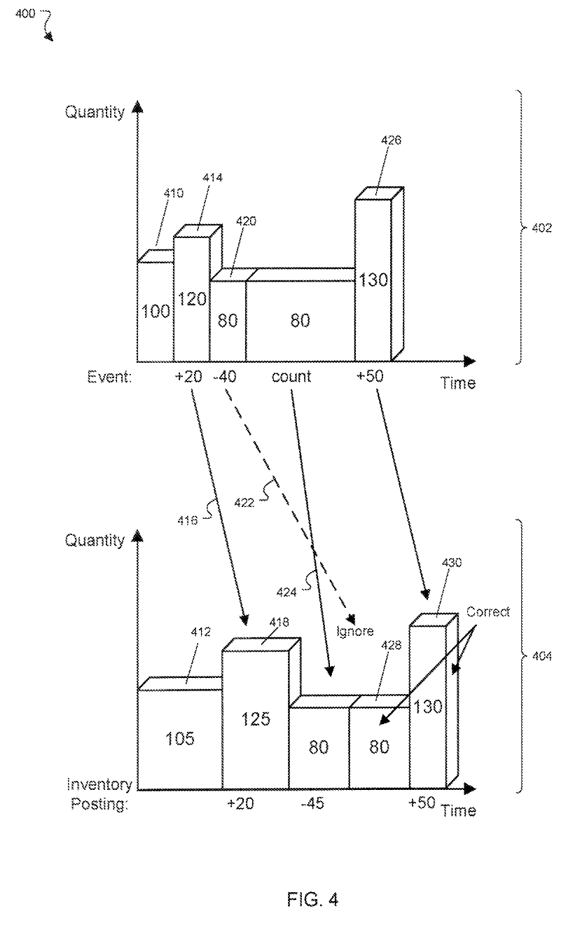

FIG. 4 is a graphical implementation 400 of the example data record in FIG. 3B. The processes and events described in FIG. 4 generally relate to the mixing of delta updates and absolute updates in an inventory management system. More particularly, the mixing of delta updates and absolute updates may lead to sequencing issues if stock postings with absolute quantities and delta quantities are handled in an erroneous order for technical reasons, for example. As an example, implementation 400 describes an absolute update overtaking a delta update in the inventory management module 120, for example. Other sequences are possible and will be described below.

As shown, FIG. 4 illustrates stock quantity changes over time. An actual count 402 (e.g., real world count) is shown compared with a book count 404. The actual count 402 begins with an initial value of 100 units (410), while the book count 404 begins with a posting of 105 units (412). Next, an incoming delta posting (e.g., +20 units) is received and the actual count 402 is increased from 100 units to 120 units (414). Accordingly, the book count 404 is increased by 20 units after the inventory posts to the system (as indicated by arrow 416). The book count 418 is currently at 125 units (e.g., 105 initial units+20 additional units).

Moving along the timeline, another delta posting (e.g., −40) is received and the actual count 402 is decreased from 120 units to 80 units (420). Upon processing the new delta posting, the system holding the actual count 402 begins a stock count for the inventory processing thus far. During the time the count is performed, the delta posting for the −40 above attempts to post to the book count system 404 (as indicated by arrow 422). The attempted posting may be ignored (422) since a stock count is underway.

Next, an absolute update can be made by the inventory management module 120, for example, to update the book count 404 with actual count data. For example, the stock count performed at arrow 424 may now post an absolute update to the book count numbers. The posting generally synchronizes the inventory accounting data and ensures that the actual count 402 and the book count 404 are aligned. As such, the previously ignored posting (e.g., −40) 420 and the difference in initial values (e.g., −5) can be reconciled during an absolute posting. In operation, the module 120 calculated the difference between book count 404 at the time of counting (125) and the actual count 402 (80). The ignored posting (−40) is now factored into book count because the transaction 420 occurred before the stock count, but posted after. In this example, the timestamp of the ignored posting was compared to the timestamp of the stock count and found to occur before the count. As such, the value should be reconciled in the system as occurring before the stock count. The initial value calculation (−5) can be reconciled in much the same way.

Upon finishing stock counts and absolute updates, the system 100 can return to receiving and posting deltas. For example, the actual count is increased by 50 units shown by block 426. The delta posting can be processed and posted to book count inventory 404. As shown, inventory counts 428 and 430 are correct according to the corresponding actual count numbers 402.

The inventory management module 120 can also handle other update/posting events in addition to the above described absolute update overtaking the delta update. For example, the module 120 may encounter a delta update overtaking a delta update. In this example, the delta updates can be handled with standard quantity updating and may be done so independent of their sequence. For example, as long as two or more delta postings occur after a stock count or before a stock count, they can be processed in any order. In some embodiments, the system can process the postings as received. An issue that can occur during this process may be a double posting of used inventory. For example, a delta posting can occur before a physical count and be posted during the stock count and then mistakenly reposted after the stock count resulting in an inaccurate count in the book stock.

The module 120 can also handle an absolute update overtaking another absolute update. Similar to the example shown in FIG. 4, an absolute update overtaking another absolute update can be synchronized in the system by ignoring late absolute postings. Here, the module 120 may calculate the difference between the book count at the time of counting and the actual count. The differences (positive or negative stock) can be reconciled accordingly. Further, the system can handle delta updates overtaking absolute updates when and if a logging mechanism is implemented such that inventory quantities can be calculated at a particular time when the absolute update was supposed to arrive. Of course, while the foregoing provide illustrations as to the various techniques, other techniques are possible.

Regardless of the software and methods used, the system 100 can manage physical inventory according to the time-stamped data occurring on the inventory and the particular action associated with such timestamps. Various internal and external systems can be used to update, modify, or otherwise manipulate data in the system 100. For example, a company's personnel can add or subtract inventory in the system 100 by scanning the inventory from the production line, at the loading dock, in a warehouse, etc. The system 100 can avoid blocking or unavailability of product in a location, such as a warehouse, during a physical inventory by providing a timestamp with any or all movement of goods within the location. The inventory reporting can then be delayed until system transactions can be reconciled. This can often enable the inventory management module 120 to accurately calculate the book stock—and reflect the physical stock—at any point in time.

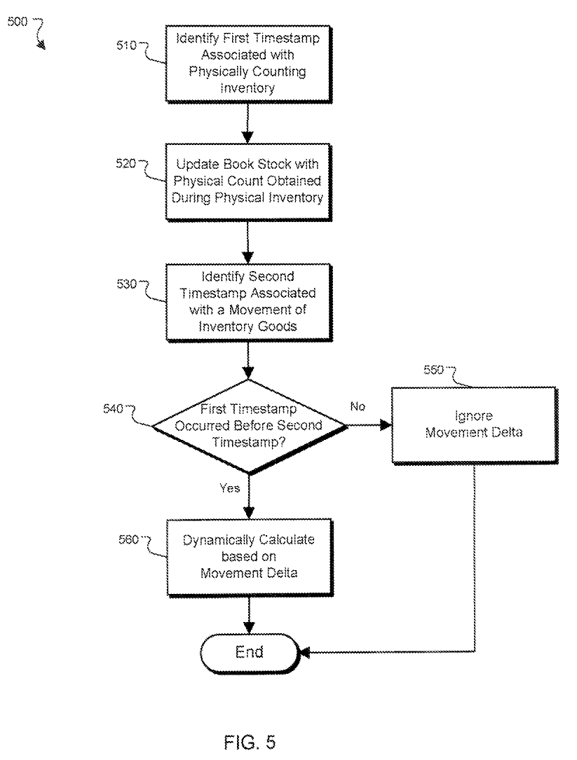

FIG. 5 illustrates an example process 500 implementing physical inventory techniques and components in accordance with one embodiment of the system 100 in FIG. 1. Regardless of the particular hardware or software architecture used, method 500 is generally capable of physical inventory processing, such as by request from inventory management module 120, and/or based on selection of parameters and selection criteria by a user using GUI 126. The following description of the flowchart illustrating method 500 focuses on the operation of the inventory management module 120 and its components or sub-modules in performing one of their respective methods or processes. But system 500 contemplates using any appropriate combination and arrangement of logical elements implementing some or all of the described functionality.

A first timestamp (e.g., order 302 in FIG. 3A) associated with the action of physically counting inventory may be identified (operation 510). For example, user 104 may use scanning device 112 to scan a selection of inventory stock into the inventory management system 102. The scanning may associate the first timestamp. An example of associating a timestamp with an event is shown in FIG. 3A (302). Here, the event performed is shown as updating an initial value at 08:00:00. In some implementations, the scanning that occurred during the event can be performed automatically, such as when inventory passes through a particular gate. At step 520, the system 100 may update the book stock with the physical count obtained during the physical inventory process (e.g., the stock count). For example, with respect to FIG. 1, the system 100 may post an absolute update to the book stock 110.

Next, a second timestamp associated with the action of moving goods may be identified (operation 530). For example, user 104 may scan new inventory into stock as shown in FIG. 3A (308). In another example, goods may be shipped to any number of customers from inventory, each of these comprising a separate movement, or combined as one movement (and subsequently separated into various shipments). Further, the movement of goods may occur in the physical inventory in several inventory locations. For example, fulfilling a stock order may require the same or different products that are stored in multiple warehouses. The movement of goods can create a delta value (e.g., positive or negative). In this example, the delta value 314 is +20 and occurred at 09:00:00. In general, the delta value may be a positive number resulting in an increase in the current inventory or a negative number resulting in a decrease in current inventory.

In this example, the timestamps can be used to determine whether or not the delta posting should be processed for a particular business day. For example, the system 100 may perform a check (operation 540) to determine whether the first identified system timestamp (e.g., FIG. 3A—08:00:00) occurred before the second identified system timestamp (e.g., FIG. 3A—09:00:00). If the first identified timestamp did not occur before the second identified timestamp, the system 100 may ignore the difference between the book stock and the physical inventory (operation 550).

But if the first identified timestamp did, indeed, occur before the second identified timestamp, the system 100 can dynamically calculate the difference between book stock and physical inventory (operation 560) using the received delta values and their associated timestamps. The operation 560 can subtract or add the delta value to the current book stock. For example, a delta posting (positive or negative) can be made to the book stock 110. In the example in FIG. 3A (308), the positive delta value +20 is added to the current book count (e.g., initial quantity (105 units)+delta update (+20 units)=updated book count (125 units)).

The preceding flowchart and accompanying description illustrate exemplary method 500. System 100 contemplates using or implementing any suitable technique for performing these and other tasks. It will be understood that these methods are for illustration purposes only and that the described or similar techniques may be performed at any appropriate time, including concurrently, individually, or in combination. In addition, many of the steps in these flowcharts may take place simultaneously and/or in different orders than as shown. Moreover, system 100 may use methods with additional steps, fewer steps, and/or different steps, so long as the methods remain appropriate.

Although this disclosure has been described in terms of certain embodiments and generally associated methods, alterations and permutations of these embodiments and methods will be apparent to those skilled in the art. For example, certain embodiments of system 100 may be a standalone, but networked, client that retrieves local information, identifies the context of the local user, and provides presentation elements associated with remote objects, applications, or other data accessible via the network. Accordingly, the above description of example embodiments does not define or constrain this disclosure. Other changes, substitutions, and alterations are also possible without departing from the spirit and scope of this disclosure.

What is claimed is:

1. Software for managing physical inventory, the software comprising computer readable instructions embodied on media and operable when executed to:
identify a first timestamp associated with a first action involving physical inventory;
identify a second timestamp associated with a second action involving the physical inventory; and
dynamically calculate book stock that reflects the physical inventory given the first and second action.

2. The software of claim 1, the first action comprising a physical count of the physical inventory.

3. The software of claim 2, the physical count at least partially utilizing a scanning device that automatically associates the first timestamp.

4. The software of claim 2, the second action comprising a movement of goods in the physical inventory.

5. The software of claim 4 further operable to receive a delta based on the goods movement and subtract the delta from current book stock.

6. The software of claim 5 further operable to:
determine a difference between book stock at the first timestamp and the physical count; and
subtract the difference from the current book stock.

7. The software of claim 6, the difference comprising a negative number resulting in an increase in the current book stock.

8. The software of claim 6, wherein the determination and subtraction are performed if the delta has been processed prior to the physical count.

9. The software of claim 1, each timestamp comprising a date and an eight-digit time value.

10. The software of claim 1, the first action comprising a movement of goods in the physical inventory associated with a delta, the second action comprising a physical count of the physical inventory, and the software further operable to:
update the book stock with the physical count; and
ignore the delta if the first timestamp is before the second timestamp.

11. A computer implemented method for managing physical inventory comprising:
identifying a first timestamp associated with a first action involving physical inventory;
identifying a second timestamp associated with a second action involving the physical inventory; and
dynamically calculating book stock that reflects the physical inventory given the first and second action.

12. The method of claim 11, the first action comprising a physical count of the physical inventory.

13. The method of claim 12, the physical count at least partially utilizing a scanning device that automatically associates the first timestamp.

14. The method of claim 12, the second action comprising a movement of goods in the physical inventory.

15. The method of claim 14 further comprising receiving a delta based on the goods movement and subtracting the delta from current book stock.

16. The method of claim 15 further comprising:
determining a difference between book stock at the first timestamp and the physical count; and
subtracting the difference from the current book stock.

17. The method of claim 16, the difference comprising a negative number resulting in an increase in the current book stock.

18. The method of claim 16, wherein the determination and subtraction are performed if the delta has been processed prior to the physical count.

19. The method of claim 11, each timestamp comprising a date and an eight-digit time value.

20. The method of claim 11, the first action comprising a movement of goods in the physical inventory associated with a delta, the second action comprising a physical count of the physical inventory, and the method further comprising:
updating the book stock with the physical count; and
ignoring the delta if the first timestamp is before the second timestamp.
